(19) United States
(12) Patent Application Publication
(10) Pub. No.: US 2004/0008633 A1
(43) Pub. Date: Jan. 15, 2004

(54) Network accessing system for computer and method of controlling the same

(75) Inventor: Jung-Min Youn, Suwon City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/318,216

(22) Filed: Dec. 13, 2002

(30) Foreign Application Priority Data
Jul. 15, 2002 (KR) 2002-41177

(51) Int. Cl. H04L 12/28

(52) U.S. Cl. 370/254

(57) ABSTRACT

A network accessing system of a computer includes a wire communicating unit for wire access to a network; a wireless communicating unit for wireless access to the network; a sensing unit for sensing a connection of the wire communicating unit to the network; and a controlling unit for disabling the wireless communicating unit when it is sensed that the wire communicating unit is connected to the network, as a result of sensing by the sensing unit. With this configuration, the present invention provides a network accessing system of a computer system equipped with both devices available for connection to the wire network and the wireless network, thereby saving power consumption by a networking device when the other device is connected to a network, and a method of controlling the same.

### CROSS-REFERENCE TO RELATED APPLICATIONS

This application claims the benefit of Korean Application No. 2002-41177 filed Jul. 15, 2002, in the Korean Intellectual Property Office, the disclosure of which is incorporated herein by reference.

### BACKGROUND OF THE INVENTION

1. Field of the Invention

The present invention relates to network accessing systems of computers and a method of controlling the same, and more particularly, to a network accessing system of a computer equipped with both an interface card for wire networking and an interface card for wireless networking, with which power is saved, and a method of controlling the same.

2. Description of the Related Art

As use of the Internet has been extensively spread out, a LAN (local area network) card for network accessing has been indispensable in the configuration of computer systems such as notebook computers or desktop computers. The LAN card can be classified into a LAN card and a wireless LAN card according to a method of accessing the network.

The LAN card is directly connected to a LAN cable in order to access the network system while the wireless LAN card is wirelessly accessed to an access point in connection with a server.

The LAN card is disadvantageous in that it is not possible to carry the computer while it is being used in access to the network. However, the LAN card is comparatively cheap and can be constructed with a simple circuit structure. For this reason, portable computers, in which a LAN card is basically built, have been on sale in the market.

In addition, it has not been unusual for portable computers such as laptop computers to be equipped with wireless LAN cards thereon, in order to increase portability thereof. Considering this, some of the computers have been equipped with both a LAN card and a wireless LAN card.

However, in order to ascertain whether the wireless LAN card can be connected to the network, the wireless LAN card receives a signal supplied from an access point periodically to maintain a connection to the access point, or it is structured to check a neighboring environment for the wireless network. Therefore, while the wireless LAN card is not connected to the network, the wireless LAN card consumes power continuously.

In particular, while the computer is accessing the network by connecting the LAN card to a LAN cable, the wireless LAN card continuously checks the environment for wireless network access, thereby consuming the power unnecessarily.

### SUMMARY OF THE INVENTION

Accordingly, it is an object of the present invention to provide a network accessing system of a computer system equipped with both devices capable of accessing both wire network and wireless network systems, wherein power consumption of one networking device is stopped while the other networking device is accessing either of the network systems, and a method of controlling the same.

Additional objects and advantages of the present invention will be set forth in part in the description that follows, and, in part, will be obvious from the description, or may be learned by practicing the present invention.

The foregoing and other objects of the present invention are achieved by providing a network accessing system of a computer-comprising a wire communicating unit for a wire access to a network; a wireless communicating unit for a wireless access to the network; a sensing unit for sensing a connection of the wire communicating unit to the network; and a controlling unit for disabling the wireless communicating unit where it is sensed that the wire communicating unit is connected to the network, as a result of sensing by the sensing unit.

In an aspect, the wire communicating unit has a LAN card formed with a connector for a connection to a network cable, and a LAN card driver for controlling driving of the LAN card; the wireless communicating unit has a wireless LAN card and a wireless LAN card driver for controlling driving of the wireless LAN card; the sensing unit senses a connection of the connector of the LAN card to the network cable; and the controlling unit controls the wireless LAN card to be suspended by disabling the wireless LAN card driver when it is sensed that the network cable is connected to the LAN card, as a result of sensing by the sensing unit.

In an aspect, the controlling unit enables the wireless communicating unit when it is sensed that the wire communicating unit is not connected to the network, as a result of sensing by the sensing unit.

In an aspect, the controlling unit enables the wireless LAN card driver to drive the wireless LAN card when it is sensed that the LAN card is disconnected from the cable, as a result of sensing by the sensing unit.

According to another aspect of the present invention, the foregoing and other objects may be also achieved by providing a method of controlling a network accessing system of a computer, comprising: determining whether a wire communicating unit and a wireless communicating unit are both equipped in the computer, the wire communicating unit for wire access to a network and the wireless communicating unit for wireless access to the network; sensing a connection of the wire communicating unit to the network, where it is determined that the wire communicating unit and the wireless communicating unit are both equipped in the computer; and disabling the wireless communicating unit when it is sensed that the wire communicating unit is connected to the network.

In an aspect, the method further comprises enabling the wireless communicating unit when it is sensed that the wire communicating unit is not connected to the network.

In an aspect, at the sensing a connection of the wire communicating unit, it is sensed whether the wire communicating unit is connected to a network cable for wire connection to the network.

In an aspect, at the disabling the wireless communicating unit, a control program of a hardware module mounted for a wireless access is disabled.

### BRIEF DESCRPTION OF THE DRAWINGS

These and other objects and advantages of the present invention will become apparent and more readily appreciated from the following description of the embodiments, taken in conjunction with the accompanying drawings of which:

FIG. 1 is a block diagram showing a network accessing environment using a network accessing system of a computer system, according to an embodiment of the present invention;

FIG. 2 is a schematic control block diagram of the network accessing system of the computer system, according to an embodiment of the present invention;

FIG. 3 shows an embodiment of the network accessing system shown in FIG. 2; and

FIG. 4 is a control flow chart of the network accessing system of the computer system, according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

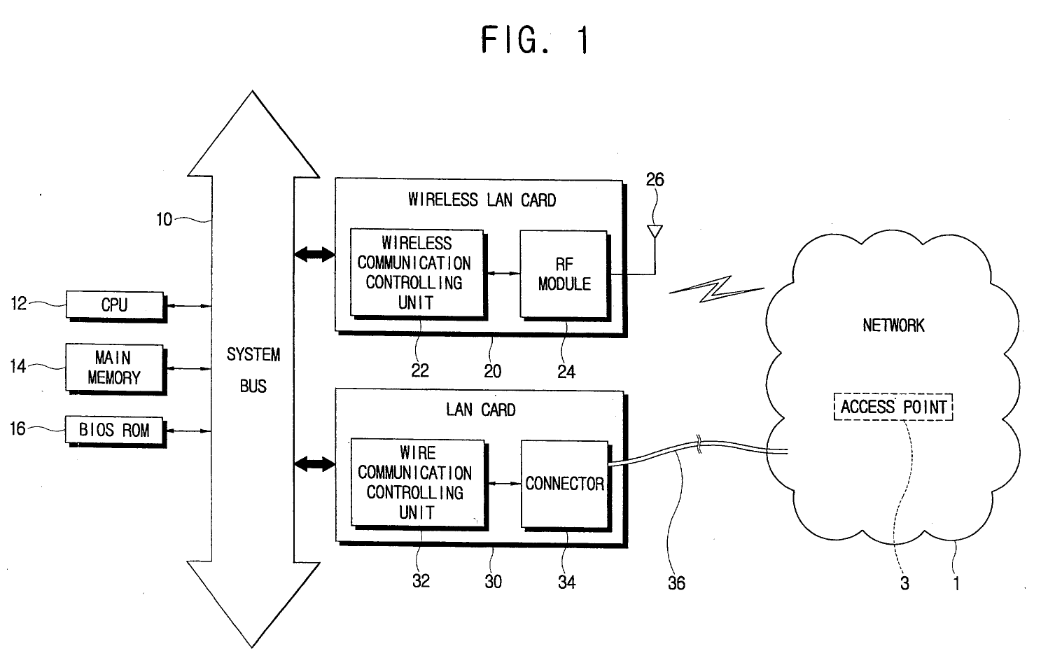

FIG. 1 is a block diagram showing a network accessing environment using a network accessing system of a computer system, according to an embodiment of the present invention. As illustrated in this figure, the computer system having the network accessing system according to the present invention is comprised of such system units as a central processing unit (CPU) 12, a main memory 14, a BIOS ROM 16 storing BIOS therein, a system bus 10 and so on, and is equipped with a wireless LAN card 20 for providing wireless access to a network 1 and a LAN card 30 for providing wire access to the network 1.

The system bus 10 manages transfers of data between the CPU 12, the memories 14 and 16, a variety of modules mounted on a PCI slot and a PCMCIA slot (not illustrated in FIG. 1), etc.

In an embodiment, the wireless LAN card 20 and the LAN card 30 are network interface cards, allowing the computer to make an access to the network 1. The wireless LAN card 20 allows the computer to wirelessly access the network 1 by wirelessly transmitting and receiving data through an access point 3 of the network 1. The LAN card allows the computer to be connected to the network 1 with a wire, by receiving and transmitting the data through a LAN cable 36 of the network 1. In an embodiment, the wireless LAN card 20 and the LAN card 30 are provided in the form of PC cards, so as to allow them to be inserted into appropriate slots of the computer, or they may be provided onboard on the motherboard.

The wireless LAN card 20 is comprised of an antenna 26 for transmitting and receiving radio signals, an RF (radio frequency) module 24, and a wireless communication controlling unit 22 transmitting and receiving the data through the antenna 26 and the RF module 24. The wireless communication controlling unit 22 processes the data of the computer system to be in transmittable form for transmission to the network 1 so as to transmit and receive the processed data wirelessly through the RF module 24 and the antenna 26. The wireless communication controlling unit 22 of the wireless LAN card 20 receives the signal supplied from the access point 3 periodically to maintain the wireless connection to the access point 3 or to check the environment of the network 1, in order to ascertain the availability for accessing the network 1.

The LAN card 30 is comprised of a connector 34 for connection to the LAN cable 36, and a wire communication controlling unit 32 for transmitting data to and receiving data from the network 1 through the LAN cable 36 connected to the connector 34. The wire communication controlling unit 32 processes the data of the computer system to be in the form transmittable to the network 1 so as to transmit the processed data to the network 1 through the LAN cable 36 connected to the connector 34, and on the other hand, transmits the data received through the connector 34 to the computer system.

As illustrated, the network accessing system of a computer system, according to an embodiment of the present invention, can be equipped with both the wireless LAN card 20 and the LAN card 30, thereby enabling both wireless access and wire access to the network 1.

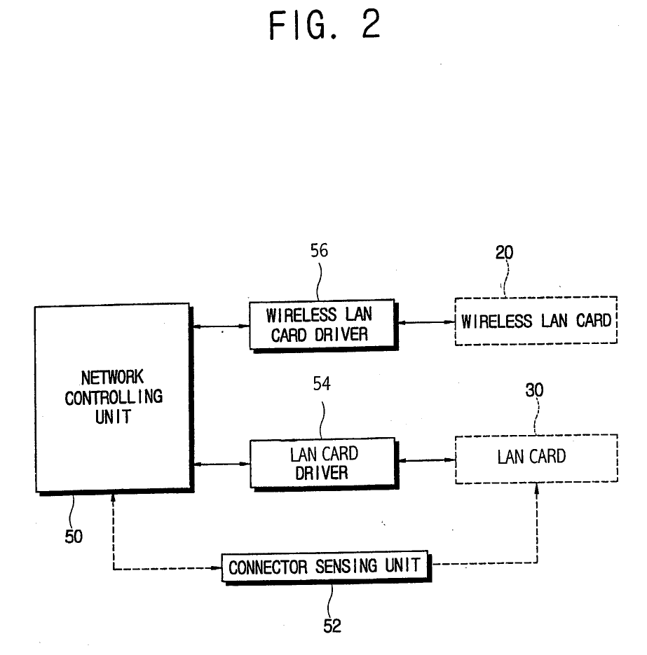

FIG. 2 is a schematic control block diagram of the network accessing system of the computer system, according to an embodiment of the present invention. As shown in this figure, the network accessing system of the computer system is comprised of a wireless LAN card 20 enabling a wireless access to the network 1, a LAN card 30 being formed with a connector 34 for connection to a LAN cable 36, a connector sensing unit 52 for sensing a connection of the LAN cable 36 to the connector 34 of the LAN card 30, a wireless LAN card driver 56 and a LAN card driver 54 for controlling the respective LAN cards 20 and 30, and a network controlling unit 50 for selectively enabling or disabling the drivers 54 or 56.

In an embodiment, the wireless LAN card 20 and the LAN card 30 are hardware units for transmitting and receiving data through a connection to the network 1. Thus, in an embodiment, the drivers 54 and 56 are necessary to logically connect either of the LAN cards 20 and 30 to the computer system.

In an embodiment, the wireless LAN card driver 56 and the LAN card driver 54 are software for controlling the respective LAN cards 20 and 30. The LAN card drivers 54 and 56 initialize the LAN cards 20 and 30, transmit the data of the computer system to the LAN cards 20 and 30, or transmit the data received from the LAN cards 20 and 30 to the computer system.

The connector sensing unit 52 senses a connection of the LAN cable 36 to the connector 34 of the LAN card 34, and supplies a signal to connect the LAN cable 36 to the network controlling unit 50.

The network controlling unit 50 disables the wireless LAN card driver 56 so as not to allow the wireless LAN card 20 to be driven when it is determined that the LAN cable 36 is connected to the connector 34 of the LAN card 30 as a result of the sensing by the connector sensing unit 52.

If it is sensed that the LAN cable 36 is connected to the connector 34 of the LAN card 30, it is considered that the computer has already been connected to the network 1 with the use of the LAN card 30, and the wireless LAN card 20 is disabled. Accordingly, a function of the wireless LAN card 20 to receive a signal supplied from the access point 3 periodically to maintain the connection to the access point 3 or check the neighboring environment of the network 1 is suspended, thereby preventing the unnecessary consumption of power.

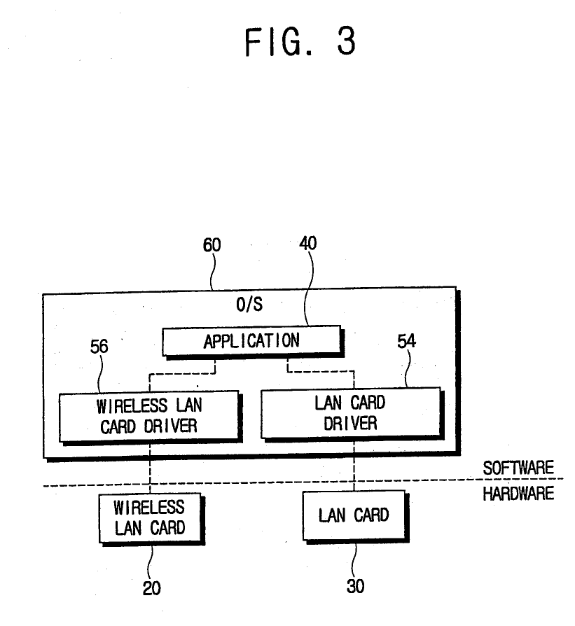

FIG. 3 shows an embodiment of the network accessing system shown in FIG. 2. As depicted in this figure, the wireless LAN card 20 and the LAN card 30 are hardware units, being controlled by their respective wireless LAN card driver 56 and the LAN card driver 54.

In an embodiment, the wireless LAN card driver 56 and the LAN card driver 54 are software for controlling the respective LAN cards 20 and 30. They initialize their respective LAN cards 20 and 30 and control data input and output between the computer system and the LAN cards 20 and 30. Here, in the case of the wireless LAN card driver 56, the driver 56 controls the wireless LAN card 20 so as to receive the signal supplied from the access point 3 periodically to maintain the wireless connection to the access point 3 or to check the neighboring environment of the network 1.

In an embodiment, an application 40 is software for performing a control function of the network controlling unit 50 shown in FIG. 2. The application 40 is a program in a higher level than the drivers 54 and 56, so called, software for performing a function of the network controlling unit 50 shown in FIG. 2. In an embodiment, the application 40 is a graphical user interface (“GUI”). That is, where the LAN cable 36 is in connection with the LAN card 30, the application 40 disables the wireless LAN card driver 56. Where the LAN cable 36 is disconnected from the LAN card 30, the application 40 enables the wireless LAN card driver 56.

The application 40, the wireless LAN card driver 56 and the LAN card driver 54 can be implemented in an operating system (O/S) 60. For example, in an embodiment, where the operating system 60 is WINDOWS™, the application 40 for controlling the LAN card drivers 54 and 56 may be a “system manager,” which is a system managing program. However, embodiments of the invention are not limited to the WINDOWS™ operating system, as any other operating system may be used.

The system manager in WINDOWS™ is a program for managing hardware units connected to the computer system. The system manager registers the hardware units mounted on the computer system with the system information, and installs drivers of each hardware unit. The network accessing system according to the present invention can be configured so as to allow the system managing program to perform the control function of the network controlling unit 50.

Therefore, where a computer system is equipped with an operating system based on WINDOWS™, the system manger (the application 40) registers hardware information of the LAN cards 20 and 30 with the system information and enables or disables the wireless LAN card driver 56 depending on connection of the LAN cable 36 to the LAN card 30 when it is ascertained that the computer system is equipped with both the LAN card 30 and the wireless LAN card 20.

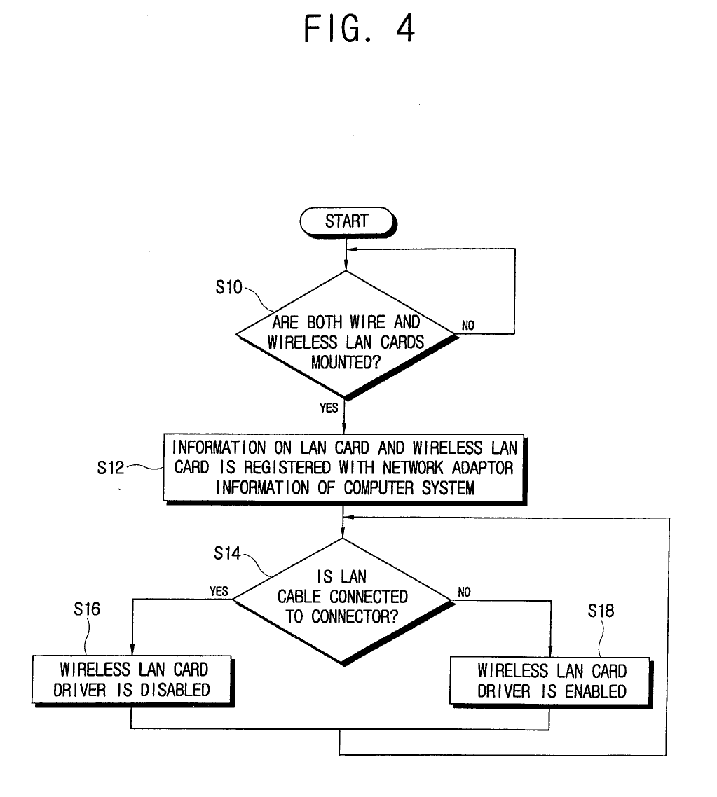

The control flow of the network accessing system of the present invention with this configuration is described in detail with reference to FIG. 4.

The network controlling unit 50 determines whether the LAN card 30 and the wireless LAN card 20 are both mounted on the computer system (S10). Where both LAN cards 20 and 30 are mounted, they are registered with the network adaptor information of the computer system (S12). The network controlling unit 50 continuously determines whether the LAN cable 36 is connected to the LAN card 30 (S14). Where it is determined that the LAN cable 36 is connected to the LAN card 30, the network controlling unit 50 disables the wireless LAN card driver 56, thereby stopping the wireless LAN card 20 from being driven (S16). Where it is determined that the LAN cable 36 is disconnected, the network controlling unit 50 enables the wireless LAN card driver 56 to thereby allow the wireless LAN card 20 to be driven (S18).

As described above, where the wireless LAN card and the LAN card are both mounted on the computer system, the wireless LAN card is disabled if the cable is connected to the LAN card. According to this, while the wire network is in use, an operation to check the environment for wireless network accessing is suspended, thereby preventing the unnecessary consumption of power.

According to the present invention, there is provided a network accessing system of a computer system equipped with both devices available for connection to the wire network and the wireless network, thereby saving power consumption by a networking device, where the other device is connected to a network, and a method of controlling the same.

The components included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A network accessing system of a computer, comprising:
a wire communicating unit for wire access to a network;
a wireless communicating unit for wireless access to the network;
a sensing unit for sensing a connection of the wire communicating unit to the network; and
a controlling unit for disabling the wireless communicating unit in response to the sensing unit sensing that the wire communicating unit is connected to the network.

2. The network accessing system according to claim 1,
wherein the wire communicating unit comprises:
a LAN card formed with a connector for a connection to a network cable; and
a LAN card driver for controlling driving of the LAN card,
wherein the wireless communicating unit comprises:
a wireless LAN card; and
a wireless LAN card driver controlling driving of the wireless LAN card,
wherein the sensing unit senses a connection of the connector of the LAN card to the network cable, and
wherein the controlling unit suspends the wireless LAN card by disabling the wireless LAN card driver in response to the sensing unit sensing that the network cable is connected to the LAN card, as a result of sensing by the sensing unit.

3. The network accessing system according to claim 1, wherein the controlling unit enables the wireless communicating unit in response to the sensing unit sensing that the wire communicating unit is not connected to the network, as a result of sensing by the sensing unit.

4. The network accessing system according to claim 2, wherein the controlling unit enables the wireless LAN card driver to drive the wireless LAN card in response to the sensing unit sensing that the LAN card is disconnected from the cable, as a result of sensing by the sensing unit.

5. A method of controlling a network accessing system of a computer, comprising:
determining whether a wire communicating unit and a wireless communicating unit are both equipped in the computer, the wire communicating unit for wire access to a network and the wireless communicating unit for a wireless access to the network;
sensing a connection of the wire communicating unit to the network in response to determining that the wire communicating unit and the wireless communicating unit are both equipped in the computer; and
disabling the wireless communicating unit in response to sensing that the wire communicating unit is connected to the network.

6. The method according to claim 5, further comprising enabling the wireless communicating unit in response to sensing that the wire communicating unit is not connected to the network.

7. The method according to claim 5, wherein the sensing of the connection of the wire communicating unit comprises sensing whether the wire communicating unit is connected to a network cable for a wire connection to the network.

8. The method according to claim 5, wherein the disabling of the wireless communicating unit comprises disabling a control program of a hardware module mounted for the wireless access.

9. A method for conserving power in a computer that is equipped with wireless and wire network connectivity, comprising:
disabling a wireless communication unit in the computer when a wire communication unit in the computer is connected to a network; and
enabling the wireless communication unit when the wire communication unit is not connected to the network.

10. The method of claim 9, further comprising:
sensing whether the wire communication unit is connected to the network.

11. The method of claim 10, wherein the sensing determines whether the wire communication unit is connected to a network cable.

12. The method of claim 9, wherein the disabling comprises disabling a wireless card driver, and wherein the enabling comprises enabling the wireless card driver.

13. A machine-readable medium for conserving power in a computer that is equipped with wireless and wire network connectivity that provides instructions, which, when executed by a machine, cause the machine to perform operations comprising:
disabling a wireless communication unit in the computer when a wire communication unit in the computer is connected to a network; and
enabling the wireless communication unit when the wire communication unit is not connected to the network.

14. The machine-readable medium of claim 13, wherein the instructions cause the machine to perform operations further comprising:
sensing whether the wire communication unit is connected to the network.

15. The machine-readable medium of claim 14, wherein the sensing determines whether the wire communication unit is connected to a network cable.

16. The machine-readable medium of claim 13, wherein the disabling comprises disabling a wireless card driver, and wherein the enabling comprises enabling the wireless card driver.

17. An apparatus for conserving power in a computer that is equipped with wireless and wire network connectivity, comprising:
a sensing unit to determine whether a wire network card is connected to a network; and
a network controller unit to disable a wireless network card when the wire network card is connected to the network and to enable the wireless network card when the wire network card is not connected to the network.

18. The apparatus of claim 17, further comprising:
a wireless card driver to control the wireless network card.

19. The apparatus of claim 18, further comprising:
a software application to control the network controller unit.

20. The apparatus of claim 19,
wherein the network controller unit disables the wireless network card by disabling the wireless card driver, and
wherein the network controller unit enables the wireless network card by enabling the wireless card driver.

21. The apparatus of claim 20, wherein the software application is a graphical user interface.

22. The apparatus of claim 20, wherein the software application and the wireless card driver are implemented in an operating system.

23. A system for conserving power in a computer that is equipped with wireless and wire network connectivity, comprising:
a network; and
a computer, comprising:
a wireless network card to wirelessly connect the computer to the network,
a wireless card driver to control the wireless network card,
a wire network card to wire connect the computer to the network via a network cable,
a sensing unit to determine whether the wire network card is connected to the network via the network cable,
a network controller unit to disable the wireless network card by disabling the wireless card driver when the wire network card is connected to the network via the network cable and to enable the wireless network card by enabling the wireless card driver when the wire network card is not connected to the network via the network cable, and
a software application to control the network controlling unit.
